(19) United States
(12) Patent Application Publication
(10) Pub. No.: US 2002/0161626 A1
(43) Pub. Date: Oct. 31, 2002

(54) Web-assistant based e-marketing method and system

(76) Inventors: Pierre Plante, Lac Masson (CA); Alain Thibault, Longueuil (CA); Efoe Wallace, Bedford (CA)

Correspondence Address: Choate, Hall & Stewart, Exchange Place, 53 State Street, Boston, MA, 02109, US

(21) Appl. No.: 10/133,069

(22) Filed: Apr. 26, 2002

Related U.S. Application Data
(60) Provisional application No. 60/286,658, filed on Apr. 27, 2001.

(51) Int. Cl. G06F 17/60

(52) U.S. Cl. 705/10

(57) ABSTRACT

An e-marketing system and method using a web-assistant system are provided. The web-assistant gives answers to customer questions all in a web format. The web-assistant is pushed to the prospective customers of a business through e-mail. Preferably, the web-assistant uses a knowledge database built using a natural language processing engine.

This application claims the priority of U.S. Provisional Patent Application No. 60/286,658, filed Apr. 27, 2001, the entire contents of which are incorporated by reference herein.

### FIELD OF THE INVENTION

The present invention relates to the field of e-marketing in general. It more particularly concerns an e-marketing system and method using a web-assistant system, and a particularly advantageous method of providing knowledge to a web-assistant.

### BACKGROUND OF THE INVENTION

E-business on the Web is growing and developing fast; however, it is observed that well known means used for marketing, for example ad banners, are relatively inefficient. Push tools have been developed in the form of out-bound e-mailers that permit one to anticipate consumer needs, through targeted or non-targeted marketing campaigns. E-marketing has become more interactive, in that it can now exploit information that is supplied by Web site visitors, explicitly or otherwise (clicks, traces, etc.). Nonetheless, the means available to Internet marketing still depend largely on diffusion.

Also, faced with the difficulty of retaining commercial site visitors and turning them into buyers, virtual salespeople have begun to be developed which, among other things, help potential customers explore virtual businesses, telling them about the company, its products and services, as well as new announcements on its Web site. These avatars are generally conceived as virtual sales representatives, helping customers achieve an assisted form of self-service. When the limits of this type of service are reached, the client receives a suggestion to contact the Web assistant's human alter ego, generally by means of e-mail. These avatars meant to increase customer loyalty. While admitting that they are relatively fruitful, it remains that the client must take the initiative to actually visit the company's Web site. The Web assistant, in these cases, is reactive rather than proactive, and it acts as sales support instead of marketing.

Web assistants known in the art usually let the customers phrase requests as they normally would, and answer in the same fashion, using everyday language, referred to as “natural language”. However, the systems that currently process the elements of a dialogue do not do so from the linguistic basis of the questions and answers. This can lead to problems of accuracy in the answers. Moreover, if the customer does not use the same words or phrases as those stored by the system, there is little if any chance of recognizing the question asked, and consequently of giving a relevant answer. It is only by using information comprising a semantic dimension, or better still lexico-semantic, that this problem can be remedied.

Finally, Web assistants are generally built on knowledge bases that take the form of either organized collections of knowledge, or FAQ (Frequently Asked Questions). In the first case, some information will unavoidably not be treated, given the “fuzzy” and unpredictable nature of the questions that the user can and will ask. In the second case, the information generally takes the form of unordered sets of information that render difficult the cross-referencing which is a fundamental feature of classical ordered bases. In addition, systems of informational recall are often based on principles that apply to the treatment of structured information, and cannot work in an unstructured context.

### OBJECTS AND SUMMARY OF THE INVENTION

In view of the above, it is an object of the present invention to provide an improved e-marketing system that uses a web-assistant.

It is another object of the present invention to provide an improved e-marketing method using such as web-assistant.

It is yet another object of the invention to provide a structured knowledge database for use by a web-assistant system.

In accordance with a first aspect of the present invention, there is therefore provides an e-marketing system for a business to market its wares to prospective customers over a network. The system includes a web-assistant system for receiving questions of the prospective customers and providing answers thereto in a web format. The web-assistant system is accessible through the network. The present e-marketing system also includes an out-bound e-mailer connected to the network, for sending therethrough an e-mail to the prospective customers. The e-mail includes accessing means for providing access to the web-assistant system.

In accordance with another aspect of the present invention, there is also provided another e-marketing system for a business to market its wares to prospective customers over a network, this system comprising a web-assistant server connected to the network. A web-assistant system is provided thereon for receiving questions of the prospective customers and providing answers thereto in a web format. The web-assistant system is accessible through the network. The e-marketing system also includes an out-bound e-mail server connected to the network for sending therethrough an e-mail to the prospective customers. The e-mail includes accessing means for providing access to the web-assistant system.

The present invention also provides an e-marketing method for a business to market its wares to prospective customers over a network. The method includes the following steps:

a) providing a web-assistant system for receiving questions of the prospective customers and providing answers thereto in a web format, the web-assistant system being accessible through the network; and

b) sending through the network an e-mail to the prospective customers, the e-mail providing access to the web-assistant system.

Finally, in accordance with yet another aspect of the present invention, there is also provided a method for generating a structured knowledge database about a subject matter, this knowledge database being usable by a web-assistant system to provide answers to questions about the subject in a web format. The method includes the steps of:

a) providing a knowledge repository containing unstructured information about the subject matter;

b) performing a linguistic analysis of the unstructured information for conceptually indexing the same, thereby obtaining the structured knowledge database, the analysis including natural language processing of the unstructured information.

Further features and advantages of the present invention will be better understood upon reading of preferred embodiments thereof with reference to the appended drawings.

### BRIEF DESCRIPTION OF THE DRAWINGS

FIG. 1 is a schematic block diagram of an e-marketing system according to a preferred embodiment of the present invention.

FIG. 2 is a schematic diagram illustrating the Web-assistant system of the e-marketing system of FIG. 1.

FIG. 3 is a flow chart illustrating the main steps of a method for generating a structured knowledge database for use by a we-assistant according to a preferred embodiment of the invention.

FIGS. 4A and 4B are flow chart detailing step b) and c) of FIG. 3, respectively.

### DESCRIPTION OF PREFERRED EMBODIMENTS OF THE INVENTION

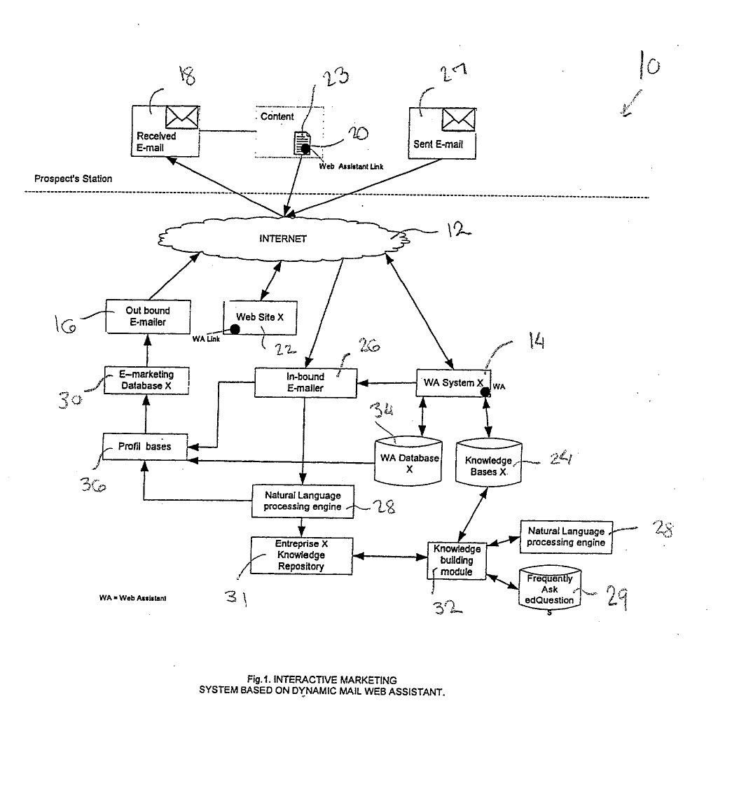

With reference to FIG. 1, there is shown a preferred embodiment of an e-marketing system 10 according to a first preferred embodiment of the present invention. This system is for use by a business or any organization wishing to market its wares, products, services, etc to prospective customers over a network 12. Preferably, the network 12 is embodied by the whole internet but the invention could equally be applied to a more restricted local network. The prospective customers are defined as including any party the business may want to reach with its marketing efforts.

The e-marketing system 10 first includes a web-assistant system 14. A web-assistant is a tool that facilitates navigation or search on a Web site. Under question/answer (QA) mode, the web-assistant permits a certain dialogue with a human visitor. In the case of the preferred embodiment it will be able to, in answering questions asked of it, either display an exact response (eventually with a link in the body), or propose a choice from a set of questions whose content bears a certain degree of relevance to the question asked, or lastly, preferably after two inconclusive attempts, facilitate the sending of an e-mail request, in order that one of the business's human agents can take over the dialogue with the visitor.

The web-assistant system 14 is preferably provided on a server connected to the network 12, where it is readily accessible through the network 12. The web-assistant is preferably “educated” to provide answers to customer questions related to the business and general and the products and services it wishes to market in particular, all in a web format. In the preferred embodiment of the invention, the web-assistant system 14 includes a knowledge database 24 from which the answers to customer questions are obtained. A knowledge-building module 32 for generating the knowledge database is preferably provided. Preferably, the knowledge-building module first amasses all relevant information susceptible to be used in the customer questions answering process in a knowledge repository 31. It then proceeds to the linguistic analysis o this information either through a list of frequently asked questions 29, or more advantageously with a natural language processing engine 28. A more detailed description of a method for generating a web-assistant knowledge database 24 particularly adapted for use with the present invention is given further below.

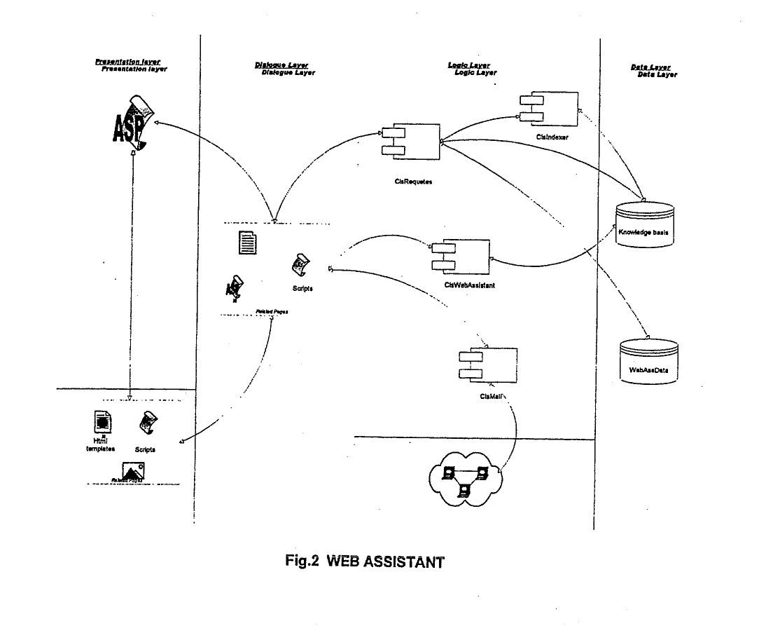

Referring to FIG. 2, there is shown the structure of a web-assistant system 14 according to a preferred embodiment of the invention. The web-assistant is comprised of a presentation layer, a dialogue layer, a logic and a data layer.

In accordance with an advantageous aspect of the present invention, the web-assistant is “pushed” directly to the prospective customers through e-mail. Referring again to FIG. 1, for this purpose, the e-marketing system 10 further includes an out-bound e-mailer 16, also provided on a server connected to the network 12. Preferably, the out-bound e-mailer 16 is an e-mail sending system allowing for the expediting of mass e-mails to pre-established lists, with various functions for sorting, exclusion, etc. This type of e-mailer is well know in the art and is often used, among other applications, in marketing campaigns. In accordance with the present embodiment of the invention, the e-mailer sends to a list of prospective customer an e-mail 18 which provides access to the web-assistant system 14. The list of prospective customers may for example be provided by a e-marketing database of the business itself, or from an external source. For example, the e-mail 18 includes a web-link 20 leading to the Web-Assistant system, which preferably opens a web page to a Web site 22 of the business wishing to conduct interactive e-marketing where the prospective user may interact with the web-assistant system. In the preferred embodiment of the invention, the contain of the e-mail includes dynamic pages in a web format integrating access to the web-assistant system. This may for example include a visual representation of a web-assistant, and one or more input fields for the prospective customer to interact with the web-assistant directly in the e-mail body.

The actual text message 23 conveyed by the e-mail may of course be tailored to the needs of the relevant e-marketing campaign. It may advantageously prompt the prospective customer to ask questions of the web-assistant provided in the e-mail.

The web-assistant system 14 also includes a web-assistant database 34. This database base holds all of the usage statistics of the web-assistant system, as well as data such as the performance of the web-assistant in comparison with a Question/Answer (QA) system. The contents of this base may be used to two ends. Firstly, to improve the web-assistant system 14 and secondly, to exploit the information stored in the e-mails of prospective clients who have questioned the web-assistant which are inserted in the mail received during the marketing campaign. These data can eventually be intersected, by the company's marketing service, with those which will have been stored after the sending of an e-mail by prospective clients who did not receive a satisfactory response during their consultation with the Web-Assistant.

The e-marketing system 10 of the present invention further preferably includes an e-marketing database 30. It preferably includes information from a variety of sources concerning potential buyers, potential client and current clients of the business. The information comes from a client base, or from the tracks left by visitors on the company's Web site, especially during their dialogues with the web-assistant or in e-mails that they sent to the business if the web-assistant did not answer questions to their satisfaction. Preferably, the e-marketing database 30 uses the same language processing engine that drives the development of the web-assistant's knowledge database, which will be further described below. The contents of the e-marketing database can thus advantageously be analyzed, and the results redirected, either to the out-bound e-mailer, where it may help determining the identity of the prospective customers receiving the e-mail, or to the web-assistant's knowledge database, which is thus enriched.

In addition, from the perspective of interactive e-marketing, it is advantageous to have at one's disposal a unique client profile base 36, linked to the e-marketing database 30. The client profile base 36 should have a share of all the information supplied by visitors, prospective clients, or current clients. The client profile data retrieved during their dialogues with the web-assistant, or through e-mails received due to unsatisfactory answers from the web-assistant, or also from electronic messages sent directly to the business are thus all stored in the same base 36. It is this base which, finally, at least partly as a function of marketing campaigns, feed the out-bound e-mailer 16 which will send a new series of messages with or without the web-assistant associated. We thus have a marketing campaign with greater or lesser degrees of interactivity.

The e-marketing system 10 also preferably includes an in-bound e-mailer 26 for receiving e-mails 27 with questions and comments from prospective customers. The customer e-mails may for example be sent in on a suggestion of the web-assistant system 14 if it has been unable to adequately respond to a particular question, or may have been prompted by other events such as a visit of the business'web site. E-mail requests may therefore be properly address by real personnel of the business and further added to the web-assistant knowledge database 24 and the e-marketing database 30.

In the preferred embodiment of the invention, the e-marketing system 10 is centered around a network 12 to which are connected an e-marketing database server, an out-bound e-mailer server, an in-bound e-mail server, a Web server hosting the business's web site, and the Web-Assistant server. All of these servers may be placed at a same location or distributed in different locations, the network 12 making the necessary connections between them. The natural language processing engine 28 is preferably provided on one of the servers above or a different one, and is preferably connected to the knowledge database building module 28 and the e-marketing database. The physical location of each server of the preferred embodiment above is immaterial to the scope of the present invention.

In accordance with another aspect of the present invention, there is provided an e-marketing method for a business to market its wares to prospective customers over a network. The method generally includes the two following steps:

a) providing a web-assistant system for receiving questions of the prospective customers and providing answers thereto in a web format, the web-assistant system being accessible through the network. The web-assistant preferably includes a knowledge database containing information about the wares of the business, this information being used to generate the answers to customer questions. Preferably, this step includes sub-steps of:

i) generating the information in the knowledge database, through a first stage of providing data related to the wares of the business, and a second stage of linguistically analyzing this data. The second stage preferably includes a natural language processing of the data; and

b) sending through the network an e-mail to said prospective customers, the e-mail providing access to the web-assistant system. The access to the web-assistant system may for example be provided through a web-link to the web-assistant system or connecting the prospective customer to the web site of the business where the web-assistant system is accessible. The e-mail may include a visual representation of a web-assistant, a message prompting the prospective customer to ask the web-assistant system a question, and interacting means for interacting with the web-assistant system. Preferably, the interacting means are embodied by at least one input field for receiving a question of the prospective customer. The answers provided by the web-assistant system may include a choice from a set of questions bearing similarities to the question asked by the prospective customer.

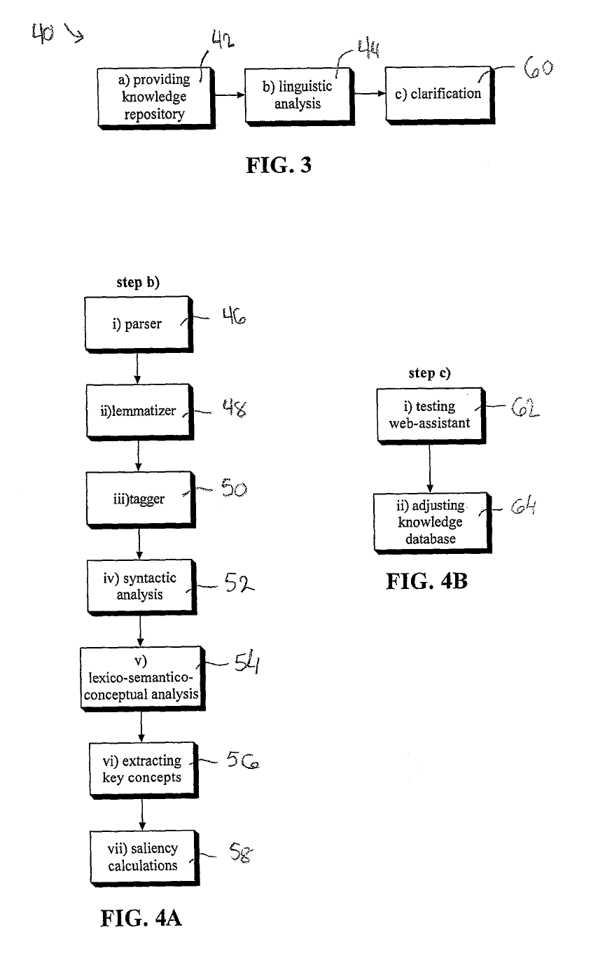

Referring to FIGS. 3, 4A and 4B, the present invention also provides a method 40 for generating a structured knowledge database about a given subject matter, such as the wares of a business, for use by a web-assistant system to provide answers to questions about this subject in a web format. Preferably, this method is carried out by a knowledge building module using a natural language processing engine.

The first step 42 of this method involves providing a knowledge repository containing unstructured information about the subject at hand. This may be defined as the base education phase, where the task is to unite information. In the preferred embodiment, one initially defines the information that is proper to a given business, which will be contained, after processing, in the web-assistant knowledge database, such as client questions, existing documentation, strategic information, etc, and group it all into the knowledge repository.

The second step 44, or the second education phase of the Web-Assistant, consists in processing the information in the knowledge repository that was constructed through a linguistic analysis thereof. Diagnostics are established on the vocabulary, on the information grouping and equivalent questions are taken into account. Following this, and depending crucially on the vocabulary diagnostic, as well as the equivalent questions predicted, one proceeds either to the SQL processing of frequent questions or, in the preferred embodiment, to the natural language processing of complex questions. Below is a description of how this analysis could advantageously be practiced.

One of the chief problems faced by any system that must analyze natural language data is that of ambiguity. Examples of ambiguity are found at all linguistic levels, that is, at the phonetic, lexical, syntactic and pragmatic levels. The question of ambiguity is often highlighted by the proponents of textual information processing models that are independent of linguistics. These models form the basis of all currently known web-assistant solutions capable of analyzing and interpreting textual questions and answers. The debate is a false one, in itself, but the solution proposed to resolve the problem, the taking into account of contextual data, is precisely one of the qualities of the system proposed in the preferred embodiment of the invention.

Research in linguistics has led to the development of a vast number of different grammars, some of which are more readily formalized on a computer. As in all applications concerned with the manipulation of text, three basic tools are used in the preferred embodiment of the invention: a parser 46, a lemmatizer 48 and a tagger 50. The parser segments the text into its minimal constituents, phrases and words. The lemmatizer maps the occurrences of words in the text to their canonical form (i.e. not inflected for gender, number and person). This permits the different possible forms of a word to be related. The tagger, finally, assigns a grammatical category to the words of a text. It is at this stage that ambiguities are brought to light. This is why a disambiguator is used, in conjunction with the tagger. This tool determines, as a function of the elements that make up the context, which of the possible categories is the most probable. In the preferred embodiment of the Invention, the analyzer is comprised of over 500 rules, which are necessary in order to identify proper categories in their context.

The next step is syntactic analysis 52, in order to find specific relations, on which non-syntactic processing is effected afterwards. In the preferred embodiment of the Invention, this stage permits not only the resolution of ambiguity, but also the retrieval, according to structural positions, of what are termed noun phrases. These are groups of words which collectively denote a single concept or object, for example object oriented modeling. This feature is particular to the engine preferred here, especially in light of the quality of the results obtained. Noun phrases can clarify the meaning of certain words and are in large part responsible for conceptual structure. Furthermore, the syntactic analysis permits the natural language processing system to treat coordination properly, thus retrieving “credit card ” from “bank and credit card ”.

After this, there is a module which conducts a lexico-semantico-conceptual analysis 54, which can retrieve a conceptual unit under any of the multiple form in which it can be realized within a certain context, for example: mapping “caesarian ” to “abdominal delivery ”, or in French, “carcéral ” to “prison ”. The preferred embodiment of the invention implements several procedures at this level which are proper to the detection of derivational, compositional, etymological and properly conceptual families. It also ensures the proper treatment of restricted generics (morphological hyperonyms) and several types of semantic equivalents, detected on the basis of attested relations or by taking into account the composition and decomposition of technical terms. It is thus that after diverse procedures, it is possible to regroup “jobs available ”, with “vacant jobs ”, or even “positions available”, “vacant ” or “offered ”. In the preferred embodiment of the invention, it is furthermore possible to modify the tables used by the lexico-semantic analyzer to take into account the vocabulary specific to a given enterprise. Existing links between words and phrases are modified, either through the addition or removal of links.

The text processing engine adds another level on top of the lexico-semantic analysis, one that permits the extraction 56 of key concepts of a text. The key concepts of a text are those expressions that best characterize its content. The extraction of key concepts, in the preferred embodiment of the invention, is founded on the conjoining of the lexico-semantic analysis and an extensive use of the power of attraction of noun phrases. During the indexing of documents, the linguistic search engine an algorithm to find key concepts and stores them in a special zone of the indexed base. Intersections in the list of concepts are taken into account when calculating the similarity between two or more documents.

The natural language processing engine proposed in the preferred embodiment of the invention is ideally-suited, by its very function, to treating neologism, to the extent that the new or unknown word respects the grammar of the language of the analyzed text. This is especially interesting, given that neologisms are frequently the linguistic reflection of innovation and given that they first appear generally in the context of informal speech. Precisely those words that an enterprise's knowledge management systems would hope to capture.

Beyond the strictly linguistic processing, there is a further engine. This module permits operating both under case-based reasoning as well as calculating similarities. The engine allows for the exploration of the representational structure of concepts, words and phrases through a parametrizable algorithm called the saliency calculation 58. Saliency essentially measures a relative distance between two objects. Their greater or lesser degree of similarity is a function of context, that is, of the nature of the other objects in the base. The saliency calculation is founded on two principles: “range gain” and “expressivity gain”. The principle of range gain stipulates the value of a piece of information increases in proportion to its rarity, in conformance with Shannon's Information Theory. Expressivity gain, on the other hand, classifies as a function of the specific nature of the piece of information. Expressivity gain allows for the treatment of asymmetry in similarity. Several algorithms, programmed with the saliency calculation, facilitate classification and diagnostic operations, in addition to clarifying emergence algorithms in the preferred embodiment of the Invention.

The solutions thus proposed permit a simple, yet efficient, management of the textual information that circulates in all organizations, for example between them and the Internet. The precision of the text mining is ensured through the performance of the linguistic analysis. Each Web page, each e-mail or other written document, regardless of its size, contains a host of information, whose organization may be detected, among other ways, through the structure of its language. During processing, each text undergoes a robust linguistic analysis, which reveals its conceptual content, as well as undergoing a process of filtration that allows for easy access to the information that each document holds, in addition to precisely characterizing the similarities and differences between documents, based on their meanings. Consequently, these may be easily classified, redistributed, summarized, regrouped or organized. The development of the linguistic portion of the preferred embodiment of the Invention has as its foundation these methods of extraction and representation of knowledge.

Always within the environment of the knowledge building module, the base education phase of the Web-Assistant is preferably followed by a phase of primary learning and various stages of clarification 60. Initially, there are some rounds of internal and semi-public testing which, from a base of archetypal questions, lead to an initial, formal, evaluation as well as a second, semi-formal evaluation. Following this, the question logs undergo a round of public testing. All the testing operations 62 favor the adjustment 64 of the information structure and editing structure of the vocabulary processing, as well as the enriching of the SQL base which ensures proper treatment of frequent questions.

Following this, the Web-Assistant regularly undergoes phases of continuing education, during which the question logs are modified, to adjust the response performances, to update existing information and add new information, taking into account changes within an enterprise and news announcements.

Although the present invention has been explained hereinabove by way of a preferred embodiment thereof, it should be pointed out that any modifications to this preferred embodiment within the scope of the appended claims is not deemed to alter or change the nature and scope of the present invention.

1. An e-marketing system for a business to market its wares to prospective customers over a network, said system comprising:
a web-assistant system for receiving questions of the prospective customers and providing answers thereto in a web format, the web-assistant system being accessible through the network; and
an out-bound e-mailer connected to said network for sending therethrough an e-mail to said prospective customers, the e-mail including accessing means for providing access to said web-assistant system.

2. The e-marketing system according to claim 1, wherein said e-mail further includes a visual representation of a web-assistant.

3. The e-marketing system according to claim 1, wherein said accessing means comprise a web-link to the web-assistant system.

4. The e-marketing system according to claim 1, further comprising a web site of said business, the web-assistant being accessible on said web site, the accessing means connecting the prospective customer thereto.

5. The e-marketing system according to claim 1, wherein said e-mail further includes interacting means for interacting with said web-assistant system.

6. The e-marketing system according to claim 5 wherein said interacting means comprise an input field for receiving a question of the prospective customer.

7. The e-marketing system according to claim 1, wherein the e-mail further includes a message prompting the prospective customer to ask the web-assistant system a question.

8. The e-marketing system according to claim 4, further comprising a web server hosting said web site.

9. The e-marketing system according to claim 1, further comprising a web-assistant server hosting the web-assistant system.

10. The e-marketing system according to claim 1, wherein the answers provided by the web-assistant system include a choice from a set of questions bearing similarities to the question asked by the prospective customer.

11. The e-marketing system according to claim 1, wherein said web-assistant system comprises a knowledge database containing information about the wares of the business, said information being used to generate said answers.

12. The e-marketing system according to claim 11, wherein the web-assistant system comprises a knowledge building module for generating said information.

13. The e-marketing system according to claim 12, wherein the knowledge building module comprises a list of frequently asked questions.

14. The e-marketing system according to claim 12, wherein the knowledge building module includes a natural language processing engine.

15. The e-marketing system according to claim 1, further comprising an in-bound e-mailer for receiving e-mail questions from the prospective customers.

16. The e-marketing system according to claim 1, further comprising an e-market database including information about said prospective customers.

17. An e-marketing system for a business to market its wares to prospective customers over a network, said system comprising:
a web-assistant server connected to the network, a web-assistant system being provided thereon for receiving questions of the prospective customers and providing answers thereto in a web format, the web-assistant system being accessible through said network; and
an out-bound e-mail server connected to said network for sending therethrough an e-mail to said prospective customers, the e-mail including accessing means for providing access to said web-assistant system.

18. The e-marketing system according to claim 17, wherein said e-mail further includes a visual representation of a web-assistant.

19. The e-marketing system according to claim 17, wherein said accessing means comprise a web-link to the web-assistant system.

20. The e-marketing system according to claim 19, further comprising a web server connected to the network, a web site of said business being provided thereon, the web-assistant being accessible from said web site.

21. The e-marketing system according to claim 17, wherein said e-mail further includes interacting means for interacting with said web-assistant system.

22. The e-marketing system according to claim 21 wherein said interacting means comprise an input field for receiving a question of the prospective customer.

23. The e-marketing system according to claim 17, wherein the e-mail further includes a message prompting the prospective customer to ask the web-assistant system a question.

24. The e-marketing system according to claim 17, wherein the answers provided by the web-assistant system include a choice from a set of questions bearing similarities to the question asked by the prospective customer.

25. The e-marketing system according to claim 17, wherein said web-assistant system comprises a knowledge database containing information about the wares of the business, said information being used to generate said answers.

26. The e-marketing system according to claim 25, wherein the web-assistant system comprises a knowledge building module for generating said information.

27. The e-marketing system according to claim 26, wherein the knowledge building module comprises a list of frequently asked questions.

28. The e-marketing system according to claim 26, wherein the knowledge building module includes a natural language processing engine.

29. The e-marketing system according to claim 17, further comprising an in-bound e-mail server for receiving e-mail questions from the prospective customers.

30. The e-marketing system according to claim 17, further comprising an e-market database including information about said prospective customers.

31. An e-marketing method for a business to market its wares to prospective customers over a network, said method comprising the steps of:
a) providing a web-assistant system for receiving questions of the prospective customers and providing answers thereto in a web format, the web-assistant system being accessible through the network; and
b) sending through the network an e-mail to said prospective customers, the e-mail providing access to the web-assistant system.

32. The e-marketing method according to claim 31, wherein said e-mail further includes a visual representation of a web-assistant.

33. The e-marketing method according to claim 31, wherein a step b) comprises including a web-link to the web-assistant system in said e-mail.

34. The e-marketing method according to claim 31, wherein step b) comprises connecting the prospective customer to a web site of said business, the web-assistant system being accessible thereon.

35. The e-marketing method according to claim 31, wherein step b) comprises including interacting means for interacting with the web-assistant system in said e-mail.

36. The e-marketing method according to claim 35 wherein said interacting means comprise an input field for receiving a question of the prospective customer.

37. The e-marketing method according to claim 31, wherein step b) further comprises including a message in said e-mail prompting the prospective customer to ask the web-assistant system a question.

38. The e-marketing method according to claim 31, wherein the answers provided by the web-assistant system include a choice from a set of questions bearing similarities to the question asked by the prospective customer.

39. The e-marketing method according to claim 31, wherein said web-assistant system comprises a knowledge database containing information about the wares of the business, said information being used to generate said answers.

40. The e-marketing method according to claim 39, wherein step a) comprises a sub-step i) of generating said information.

41. The e-marketing method according to claim 40, wherein sub-step a) i) comprises a first stage of providing data related to said wares of the business.

42. The e-marketing method according to claim 41, wherein sub-step a) i) comprises a second stage of linguistically analyzing said data.

43. The e-marketing method according to claim 42, wherein said second stage of sub-step a) i) comprises a natural language processing of said data.

44. A method for generating a structured knowledge database about a subject matter, said knowledge database being usable by a web-assistant system to provide answers to questions about said subject in a web format, the method comprising the steps of:
a) providing a knowledge repository containing unstructured information about said subject matter;
b) performing a linguistic analysis of the unstructured information for conceptually indexing the same, thereby obtaining the structured knowledge database, said analysis including natural language processing of the unstructured information.

45. The method according to claim 44, wherein said subject matter includes the wares of a business.

46. The method according to claim 44, wherein step b) comprises sub-steps of:
i) segmenting the unstructured information into word constituents;
ii) mapping each of said word constituents to a corresponding canonical form thereof; and
iii) assigning a grammatical category to each of said word constituents.

47. The method according to claim 46, wherein the assigning of sub-step iii) takes into account a contextual positioning of said word constituents.

48. The method according to claim 47, wherein step b) comprises a further sub-step of:
iv) performing a syntactic analysis of the unstructured information for identifying groups of words collectively denoting a single concept.

49. The method according to claim 48, wherein step b) comprises a further sub-step of:
v) performing a lexico-semantico-conceptual analysis of said information for mapping word constituents and groups of word relating to a same concept.

50. The method according to claim 49, wherein step b) comprises a further sub-step of:
vi) extracting key concepts of said unstructured information.

51. The method according to claim 50, wherein step b) comprises a further sub-step of:
vii) performing saliency calculations on said unstructured information.

52. The method according to claim 44, comprising a further step c) of clarifying said structure knowledge database, said step c) comprising sub-steps of:
i) testing a web-assistant system using said structured knowledge database; and
ii) adjusting the structured knowledge database based on results of said testing.
